(19) United States
(12) Patent Application Publication
(10) Pub. No.: US 2011/0288915 A1
(43) Pub. Date: Nov. 24, 2011

(54) CONTROL APPARATUS AND CONTROL METHOD FOR DIGITAL SIGNAGE TERMINAL

(75) Inventor: Hiroki Mochizuki, Shizuoka (JP)

(73) Assignee: TOSHIBA TEC KABUSHIKI KAISHA, Tokyo (JP)

(21) Appl. No.: 13/107,041

(22) Filed: May 13, 2011

(30) Foreign Application Priority Data
May 21, 2010 (JP) 2010-117509

(51) Int. Cl. G06Q 30/00

(52) U.S. Cl. 705/14.4

(57) ABSTRACT

According to one embodiment, a control apparatus for a digital signage terminal includes an editing unit and a transmitting unit. When a POS (point of sales) server which processes article sales data as of when article information is inputted generates a start command for an event related to article sales promotion, the editing unit edits a content of digital signage specialized in a content of the event. The transmitting unit transmits, to the digital signage terminal, the edited content together with an instruction command for switching a content outputted from the digital signage terminal, from a content according to a schedule to the edited content.

### CROSS-REFERENCE TO RELATED APPLICATIONS

This application is based upon and claims the benefit of priority from Japanese Patent Application No. 2010-117509, filed on May 21, 2010, the entire contents of which are incorporated herein by reference.

### FIELD

Embodiments described herein relate generally to a control apparatus and method for a digital signage terminal for outputting digital signage contents according to a predetermined schedule.

### BACKGROUND

As a mechanism to present contents such as advertisements, events or notifications to unspecified people, a system which displays digitized contents on a digital signage terminal such as a display device, that is, a so-called digital signage system is known. The existing digital signage system only switches contents to be displayed on the digital signage terminal according to a preset schedule.

At a mass retailer such as a supermarket, preferential treatment projects are set based on the store manager's determination about business opportunities. The preferential treatment projects include special offer project (time-limited services) to sell designated articles at special prices in a specific time slot, discount project to reduce the prices of sacrifice articles or articles immediately before the expiry date, and point project to increase the multiplication rate of service points when designated articles are purchased.

When such preferential treatment projects are implemented, not only the quality of the projects but also how efficiently the projects can be presented to shoppers is important. Presentation to shoppers using a digital signage system is convenient.

### BRIEF DESCRIPTION OF THE DRAWINGS

FIG. 1 shows the overall configuration of a store system according to an embodiment.

FIG. 2 is a block diagram showing the configuration of essential parts of a content management server included in the system.

FIG. 3 shows an example of data stored in a template database provided in the content management server.

FIG. 4 is a block diagram showing the configuration of essential parts of a display control server included in the system.

FIG. 5 shows the configuration of a display management table provided in the display control server.

FIG. 6 is a block diagram showing the configuration of essential parts of a POS server included in the system.

FIG. 7 shows an example of data stored in a project database provided in the POS server.

FIG. 8 is a flowchart showing main procedures for processing executed by the CPU of the POS server according to a preferential treatment project management program in the first embodiment.

FIG. 9 is a flowchart showing main procedures for processing executed by the CPU of the content management server according to a content distribution program in the first embodiment.

FIG. 10 is a flowchart showing main procedures for processing executed by the CPU of the display control server according to a display control program in the first embodiment.

FIG. 11 shows an example of data stored in a displayed article database provided in the content management server in a second embodiment.

FIG. 12 is a flowchart showing main procedures for processing executed by the CPU of the content management server according to the content distribution program in the second embodiment.

FIG. 13 is a flowchart showing main procedures for processing executed by the CPU of the display control server according to the display control program in the second embodiment.

FIG. 14 is a block diagram showing the configuration of essential parts of the POS server according to a third embodiment.

FIG. 15 is a flowchart showing main procedures for processing executed by the CPU of the POS server according to the preferential treatment project management program in the third embodiment.

FIG. 16 shows an example of data stored in a related database provided in the POS server in a fourth embodiment.

FIG. 17 is a flowchart showing main procedures for processing executed by the CPU of the POS server according to the preferential treatment project management program in the fourth embodiment.

FIG. 18 is a flowchart showing main procedures for processing executed by the CPU of the POS server according to store closing operation program in the fourth embodiment.

### DETAILED DESCRIPTION

In general, according to one embodiment, a control apparatus for a digital signage terminal includes an editing unit and a transmitting unit. When a POS (point of sales) server which processes article sales data as of when article information is inputted generates a start command for an event related to article sales promotion, the editing unit edits a content of digital signage specialized in a content of the event. The transmitting unit transmits, to the digital signage terminal, the edited content together with an instruction command for switching a content outputted from the digital signage terminal, from a content according to a schedule to the edited content.

Hereinafter, embodiments of a digital signage terminal control apparatus will be described with reference to the drawings. The embodiments relate to a store system 1 constructed in a supermarket which implements preferential treatment projects including special offer project, discount project and point project.

### First Embodiment

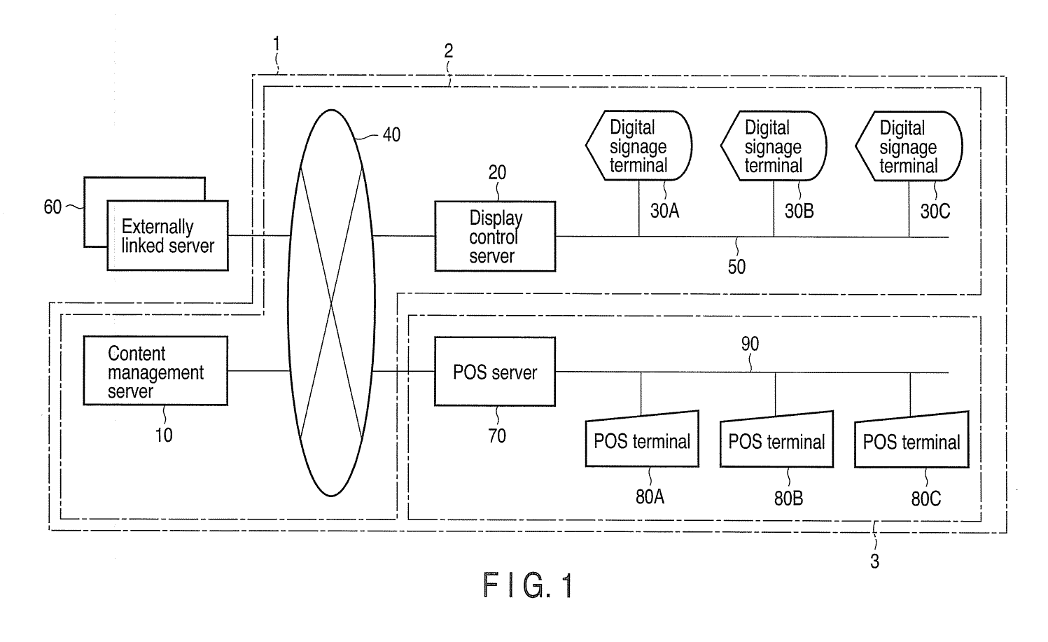

FIG. 1 shows the overall configuration of the store system 1. The store system 1 includes a digital signage system 2 and a POS system 3.

The digital signage system 2 includes a content management server 10, a display control server 20, and plural digital signage terminals 30 (30A, 30B, 30C, etc.). The content management server 10 connects to the display control server 20 via a communication network 40 such as the internet. The display control server 20 connects to each digital signage terminal 30 via a in-store network 50 such as LAN (local area network).

Each digital signage terminal 30 installed at each sales section in the store or in the doorway of the store or the like has a display that can display a dynamic image or still image. Each digital signage terminal 30 displays, on the display, a digitized content such as advertisement, event or notification distributed from the content management server 10, under the control of the display control server 20.

The content management server 10 edits the content of digital signage based on information provided from an externally linked server 60 connected via the communication network 40, and thus creates a reproduction schedule for the content. The content management server 10 transmits data of the content and the reproduction schedule to the display control server 20 via the communication network 40.

In the display control server 20, the data of the content and the reproduction schedule received from the content management server 10 is stored. The display control server 20 controls each digital signage terminal 30 according to the reproduction schedule and causes the digital signage terminal 30 to display the received content. The data of the content and the reproduction schedule may be common among all the digital signage terminals 30 or may be different from one digital signage terminal 30 to another.

The POS system 3 includes a POS server 70 and plural POS terminals 80 (80A, 80B, 80C, etc.). The POS server 70 connects to each POS terminal 80 via an in-store network 90 that is a different system from the in-store network 50.

Each POS terminal 80 installed at the checkout point in the store registers sales data of articles purchased by customers. Each POS terminal 80 then calculates the total amount of articles purchased by each customer and processes price payment data in relation to the total amount.

The POS server 70 performs centralized management of the registration of article sales data executed at each POS terminal 80. The POS server 70 then collects the article sales data registered at each POS terminal 80 via the in-store network 90. The POS server 70 totals various sales data including sales by item, sales by article category, sales by time slot and sales by customer profile, based on the collected article sales data.

The POS server 70 is connected with the communication network 40 and linked with the content management server 10 and the display control server 20.

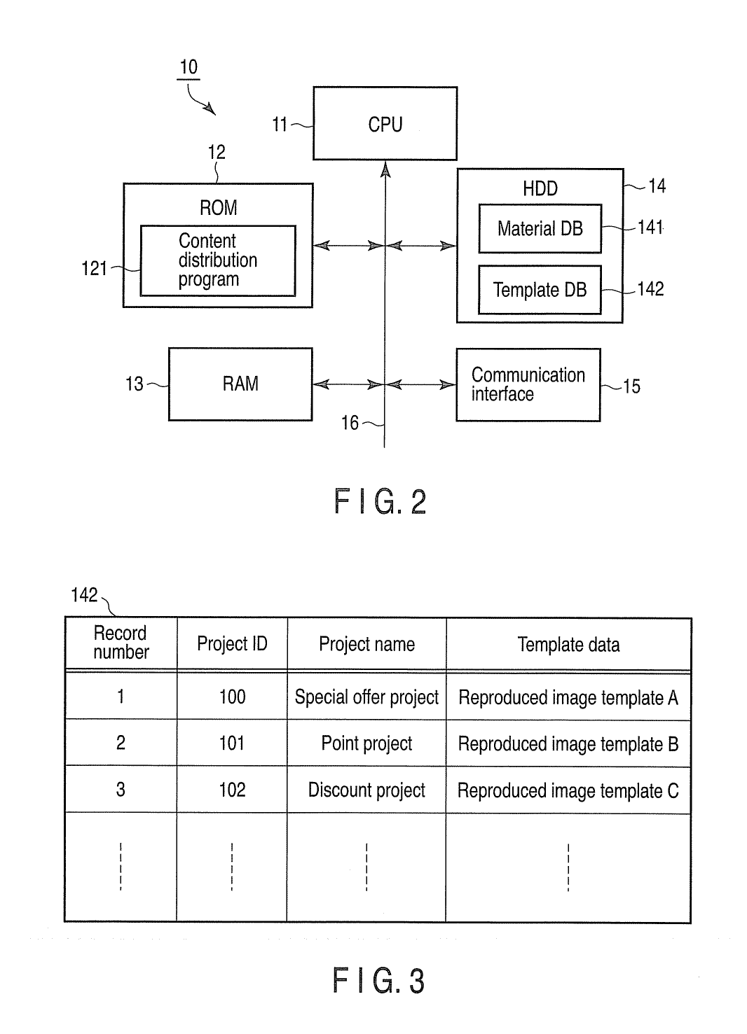

FIG. 2 is a block diagram showing the configuration of essential parts of the content management server 10. The content management server 10 includes a CPU (central processing unit) 11, a ROM (read only memory) 12, a RAM (random access memory) 13, an HDD (hard disk drive) 14, and a communication interface 15. The CPU 11 connects to the ROM 12, the RAM 13, the HDD 14 and the communication interface 15 via a bus line 16 such as address bus or data bus. The communication interface 15 is connected to the communication network 40.

At least a material database 141 and a template database 142 are saved in the HDD 14. In the material database 141, material data of contents provided from the externally linked server 60 is stored. In the template database 142, reproduction image templates necessary for editing the contents of digital signage specialized in the contents of a preferential treatment project, which is an event related to article sales promotion.

FIG. 3 shows an example of data stored in the template database 142. As shown in FIG. 3, template data records describing project ID, project name and template data are stored in order of record number in the template database 142. Project ID is information for identifying a preferential treatment project specified by the corresponding project name.

That is, in the example of FIG. 3, the record of record number [1] describes project ID, project name and reproduction image template data A of a special offer project. The record of record number [2] describes project ID, project name and reproduction image template data B of a point project. The record of record number [3] describes project ID, project name and reproduction image template data C of a discount project.

In the content management server 10 having such configuration, a content distribution program 121 is stored in the ROM 12. The CPU 11 realizes the following first to sixth functions according to the program 121.

First function: to register content material data received from the externally linked server 60 to the material database 141.

Second function: to edit content data to be displayed on the digital signage terminal 30 and create a content file.

Third function: to create a content reproduction schedule and create a schedule file.

Fourth function: to transmit the content file and the schedule file.

Fifth function: to edit urgent distribution content data using template data and create an urgent distribution file.

Sixth function: to transmit the urgent distribution file.

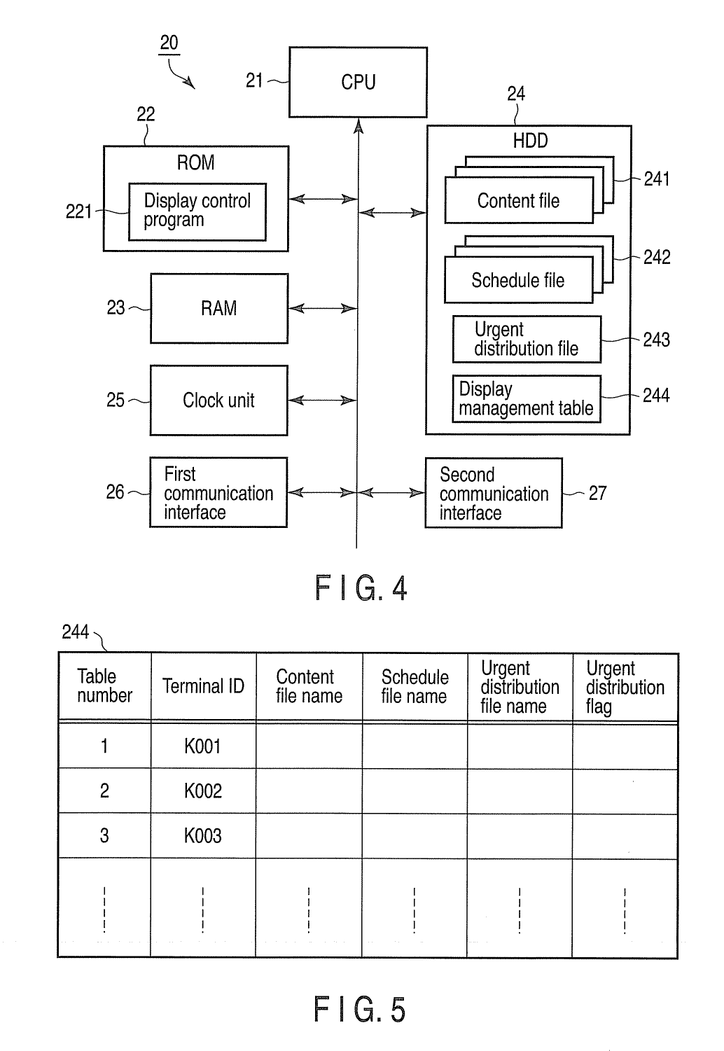

FIG. 4 is a block diagram showing the configuration of essential parts of the display control server 20. The display control server 20 includes a CPU 21, a ROM 22, a RAM 23, an HDD 24, a clock unit 25, a first communication interface 26 and a second communication interface 27. The CPU 21 connects to the ROM 22, the RAM 23, the HDD 24, the clock unit 25, the first communication interface 26 and the second communication interface 27 via a bus line 28 such as address bus or data bus.

The clock unit 25 measures the current date and time. The first communication interface 26 is connected to the communication network 40. The second communication interface 27 is connected to the in-store network 50.

At least a content file 241, a schedule file 242, an urgent distribution file 243 and a display management table 244 are saved in the HDD 24. The content file 241 and the schedule file 242 are saved for each digital signage terminal 30.

The content file 241 describes data of a content group displayed according to a schedule that is preset in the corresponding digital signage terminal 30. The schedule file 242 describes schedule data for displaying the content group on the corresponding digital signage terminal 30. The urgent distribution file 243 describes data of an urgent distribution content displayed on each digital signage terminal 30 by temporary interruption.

In the display management table 244, data areas for terminal ID, content file name, schedule file name, urgent distribution file name and urgent distribution flag are formed, corresponding to a series of table numbers 1, 2, 3, etc., as shown in FIG. 5.

The terminal ID is identification information for identifying each individual digital signage terminal 30. The content file name, schedule file name and urgent distribution file name are the identification names of the content file 241, the schedule file 242 and the urgent distribution file 243 allocated to the digital signage terminal 30 specified by the corresponding terminal ID.

The urgent distribution flag is information for identifying whether or not to display data of an urgent distribution content on the digital signage terminal 30 specified by the corresponding terminal ID. In this embodiment, the urgent distribution flag is set to “1” when displaying data of an urgent distribution content, and reset to “0” when not displaying the data.

In the display control server 20 having such configuration, a display control program 221 is stored in the ROM 22. The CPU 21 realizes the following first to third functions according to the program 221.

First function: to receive the content file 241 and the schedule file 242 via the communication network 40 and update the display management table 244.

Second function: to receive the urgent distribution file 243 via the communication network 40 and update the display management table 244.

Third function: to display the content on each digital signage terminal 30 according to the data of the display management table 244.

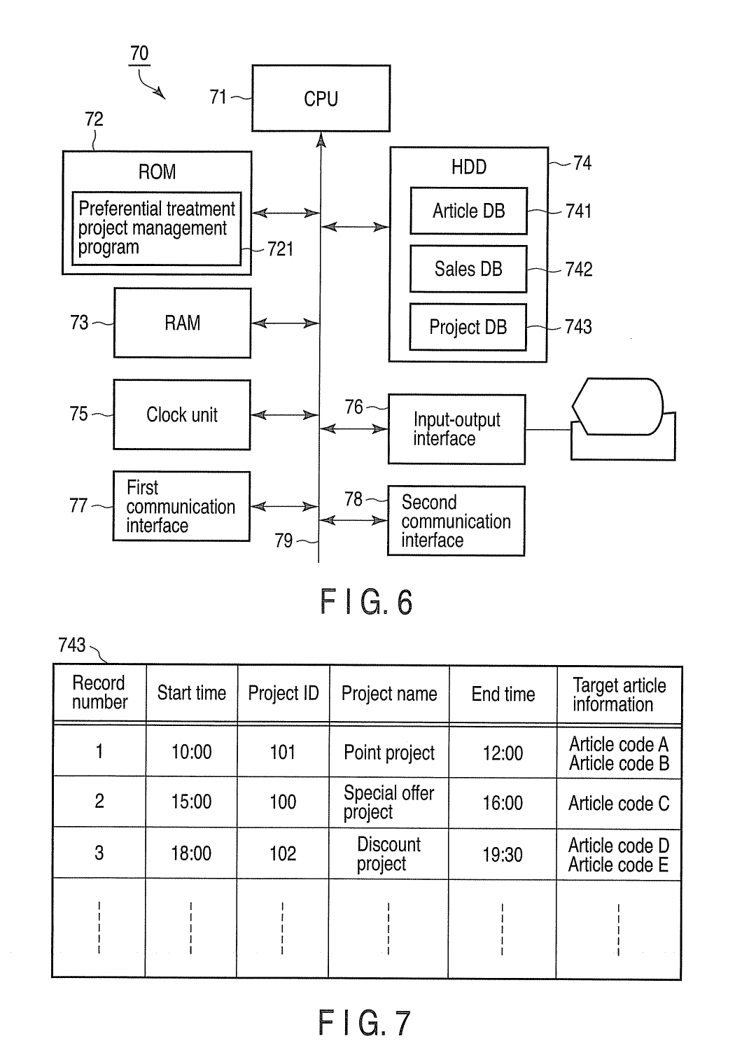

FIG. 6 is a block diagram showing the configuration of essential parts of the POS server 70. The POS server 70 has a CPU 71, a ROM 72, a RAM 73, an HDD 74, a clock unit 75, an input-output interface 76, a first communication interface 77 and a second communication interface 78. The CPU 71 connects to the ROM 72, the RAM 73, the HDD 74, the clock unit 75, the input-output interface 76, the first communication interface 77 and the second communication interface 78 via a bus line 79 such as address bus or data bus.

The input-output interface 76 transmits and receives signals to and from input-output devices such as keyboard, pointing device and display. The first communication interface 77 is connected to the communication network 40. The second communication interface 78 is connected to the in-store network 90.

At least an article database 741, a sales database 742 and a project database 743 are saved in the HDD 74. In the article database 741, information including article code, article category code, article name, regular unit price and special unit price of all the articles sold in the store is stored. In the sales database 742, article sales data including the number of items sold and the amount of sales of each article, classified by item, by article category, by time slot, by customer profile and the like is stored. In the project database 743, information about execution schedule of preferential treatment projects including special offer project, point project, discount project and the like is stored.

FIG. 7 shows an example of data stored in the project database 743. As shown in FIG. 7, project data records describing start time, project ID, project name, end time, and target article information are stored in order of record number in the project database 743.

The project ID is information for identifying a preferential treatment project specified by the corresponding project name. The start time and end time indicate the period when the preferential treatment project is implemented. The target article information is the article code of a target article of the preferential treatment project. When there are plural target articles, the article codes of these articles are described as target article information.

That is, in the example of FIG. 7, the record of record number [1] describes the project ID, project name, start time, end time and article code of a point project to be executed from 10:00 to 12:00 targeting the article of article code A and the article of article code B. The record of record number [2] describes the project ID, project name, start time, end time and article code of a special offer project to be executed from 15:00 to 16:00 targeting the article of article code C. The record of record number [3] describes the project ID, project name, start time, end time and article code of a discount project to be executed from 18:00 to 19:30 targeting the article of article code D and the article of article code E.

Addition and deletion of records to and from the project database 743 can be properly carried out by an operator operating the input-output device connected to the input-output interface 76.

In the POS server 70 having such configuration, a preferential treatment project management program 721 is stored in the ROM 72. The CPU 71 realizes the following first to third functions according to the program 721.

First function: to update the project database 743.

Second function: to control article sales data processing at each POS terminal 80 according to the data stored in the project database 743.

Third function: to control digital signage content distribution according to the data stored in the project database 743.

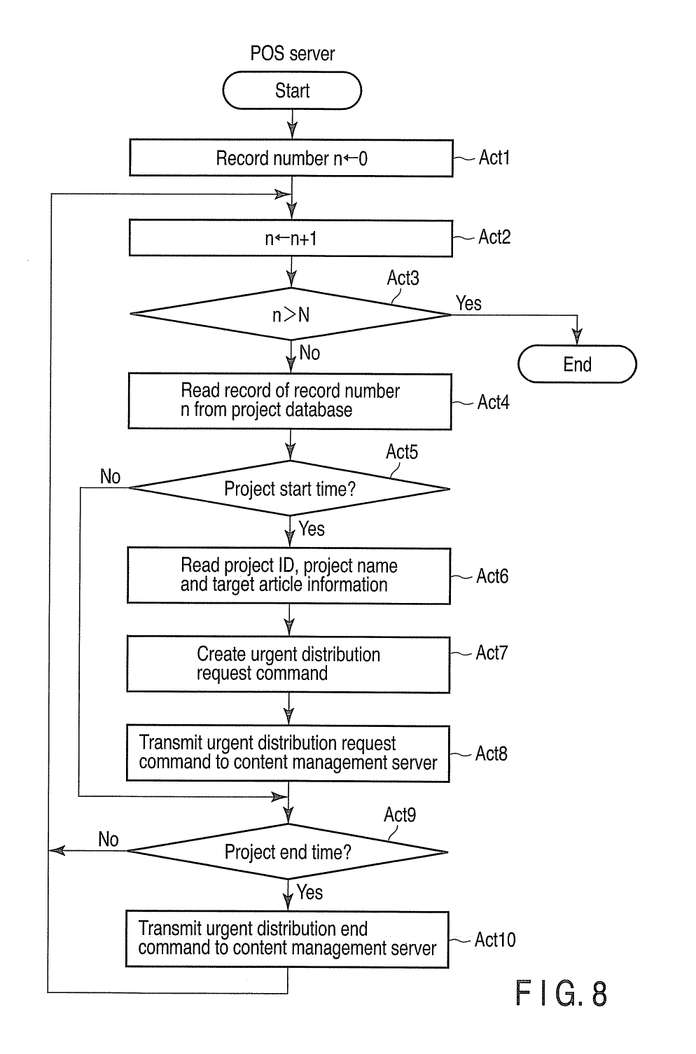

Here, the third function executed by the CPU 71 according to the preferential treatment project management program 721 will be described specifically with reference to the flowchart of FIG. 8. The CPU 71 starts processing according to the procedures shown in the flowchart of FIG. 8 every time the current time measured by the clock unit 75 is updated, for example, by one minute.

First, the CPU 71 resets a record number counter n to “0” (ACT 1). Next, the CPU 71 increments the record number counter n by “1” (ACT 2). The CPU 71 then determines whether the counter n is greater than a preset value N or not (ACT 3). The preset value N is the total number of project data records registered in the project database 743.

When the counter n is not greater than the preset value N (NO in ACT 3), the CPU 71 reads a project data record Rn of record number n (n being the count value) from the project database 743 (ACT 4). The CPU 71 determines whether the start time of the record Rn coincides with the current time or not (ACT 5).

When the start time coincides with the current time (YES in ACT 5), the CPU 71 reads out the project ID, project name and target article information from the record Rn (ACT 6). The CPU 71 then creates an urgent distribution request command with the project ID, project name and target article information that is read out (ACT 7), and transmits this command to the content management server 10 via the communication interface 77 (ACT 8).

When the start time of the record Rn does not coincide with the current time (NO in ACT 5), the CPU 71 does not execute the processing of ACT 6 to ACT 8.

Next, the CPU 71 determines whether the end time of the record Rn coincides with the current time or not (ACT 9). When the end time does not coincide with the current time (NO in ACT 9), the CPU 71 returns to the processing of ACT 2. The CPU 71 then increments the counter n further by “1” and executes the processing of ACT 3 and the subsequent processing again.

Meanwhile, when the end time of the record Rn coincides with the current time (YES in ACT 9), the CPU 71 creates an urgent distribution end command with the project ID of the record Rn. The CPU 71 then transmits the command to the content management server 10 via the communication interface 77 (ACT 10). After that, the CPU 71 returns to the processing of ACT 2. The CPU 71 then increments the counter n further by “1” and executes the processing of ACT 3 and the subsequent processing again.

In this manner, the CPU 71 repeats processing of ACT 3 to ACT 10 every time the counter n is incremented. When the counter n exceeds the preset value N (YES in ACT 3), the CPU 71 ends the processing of this time.

Thus, the POS server 70 transmits an urgent distribution request command to the content management server 10 when the start time of a preferential treatment project registered in the project database 743 comes. The urgent distribution request command includes the project ID, project name and target article information of that project.

The POS server 70 transmits an urgent distribution end command to the content management server 10 when the end time of the preferential treatment project comes. The urgent distribution end command includes the project ID of that project.

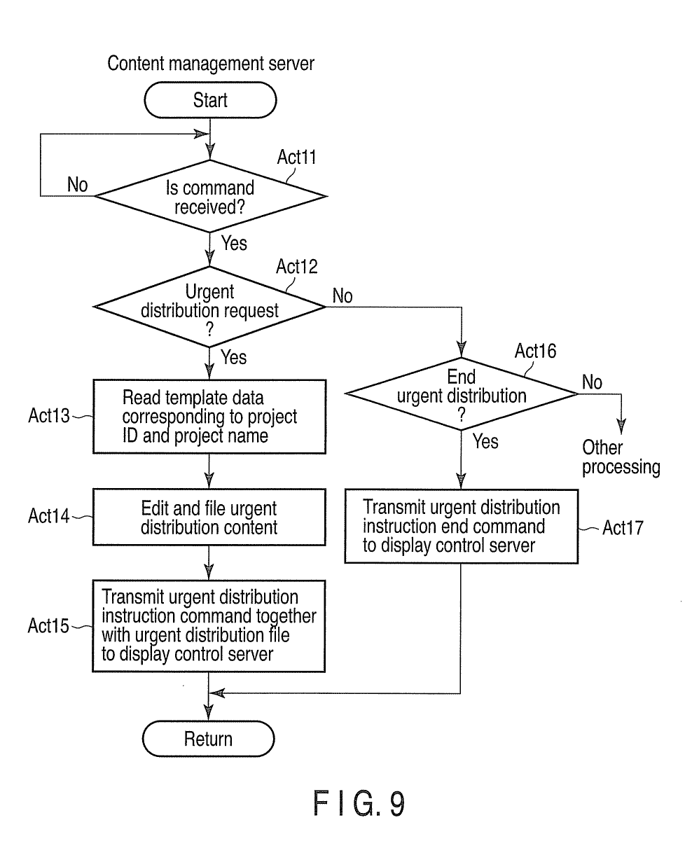

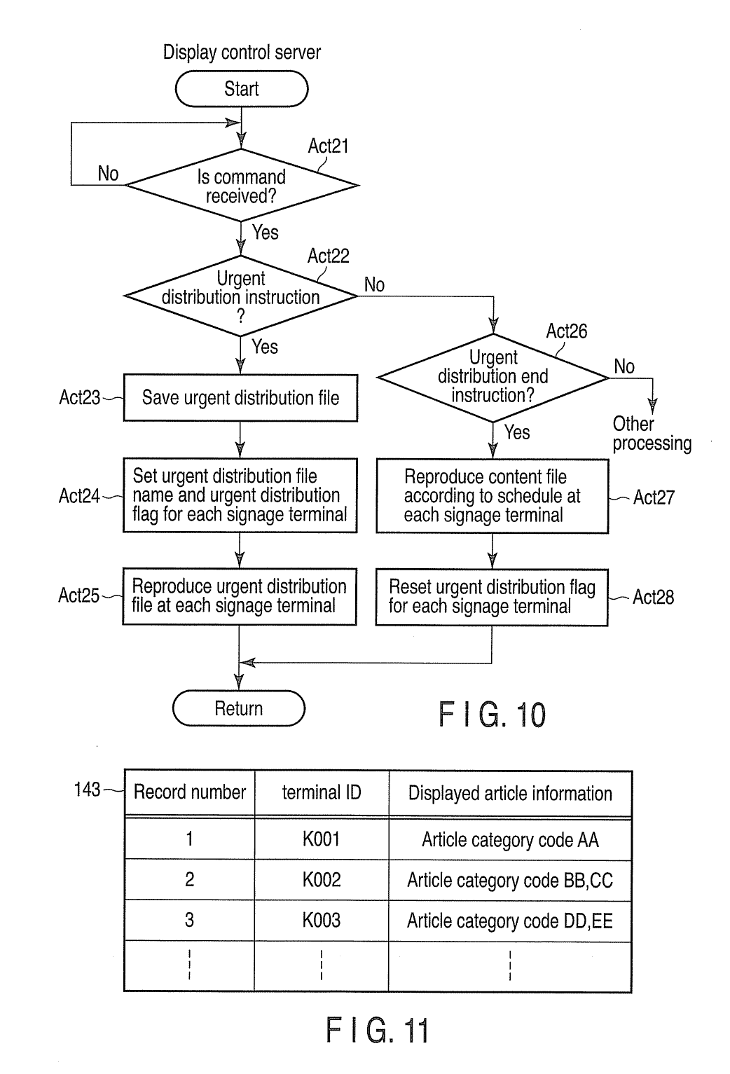

The CPU 11 of the content management server 10 receiving the urgent distribution request command and the urgent distribution end command executes processing according to the procedures shown in the flowchart of FIG. 9. This processing is equivalent to the fifth function and the sixth function of the first to sixth functions to be executed according to the content distribution program 121.

The CPU 11 waits for a command (ACT 11). When a command is received via the communication interface 15 (YES in ACT 11), the CPU 11 discriminates the type of the command (ACT 12, ACT 16).

When the received command is an urgent distribution request command (YES in ACT 12), the CPU 11 acquires the project ID and project name from the command. The CPU 11 then reads a template data record Rt which coincides with this project ID and project name from the template database 142 (ACT 13).

The CPU 11 edits an urgent distribution content of digital signage, using reproduction image template data set in the template data record Rt that is read, and the target article information included in the received command (ACT 14: editing unit).

Specifically, the CPU 11 accesses the POS server 70 via the communication network 40. The CPU 11 then reads article information (article name, regular unit price, special unit price and the like) registered in the article database 741 in association with the article code included in the target article information, from the POS server 70. Next, the CPU 11 allocates the article information that is read to the reproduction image template data in order to edit the urgent distribution content. The CPU 11 registers edited content as the urgent distribution file 243 in the material database 141. Here, the file name of the urgent distribution file 243 includes the current date, the project ID, and the article name of the article information.

After that, the CPU 11 creates an urgent distribution instruction command. This command is a command for switching the content outputted from the digital signage terminal 30, from a content according to a schedule to an urgently distributed content. The CPU 11 transmits the urgent distribution instruction command together with the urgent distribution file 243 registered in the material database 141 to the display control server 20 via the communication interface 15 (ACT 15: transmitting unit). Then, the CPU 11 ends the reception of the urgent distribution request command.

Meanwhile, when the received command is an urgent distribution end command (YES in ACT 16), the CPU 11 creates an urgent distribution instruction end command. This command is a command for returning the content outputted from the digital signage terminal 30, from the urgently distributed content to the content according to the schedule. This command includes the file name of the urgent distribution file created based on the project ID and current date included in the urgent distribution end command.

The CPU 11 transmits the urgent distribution instruction end command to the display control server 20 via the communication interface 15 (ACT 17: transmitting unit). Then, the CPU 11 ends the reception of the urgent distribution end command.

In this manner, when a start command (urgent distribution request command) of a preferential treatment project is generated at the POS server 70, the content management server 10 edits a digital signage content specialized in the event content of the project and creates the urgent distribution file 243. The content management server 10 then transmits the urgent distribution file 243 together with an urgent distribution instruction command to the display control server 20.

When an end command (urgent distribution end command) of this preferential treatment project is generated at the POS server 70, the content management server 10 transmits an urgent distribution end instruction command to the display control server 20.

The CPU 21 of the display control server 20 receiving the urgent distribution instruction command and the urgent distribution end instruction command executes processing according to the procedures shown in the flowchart of FIG. 10. This processing is equivalent to the second function and the third function of the first to third functions to be executed according to the display control program 221.

The CPU 21 waits for a command (ACT 21). When a command is received via the first communication interface 26 (YES in ACT 21), the CPU 21 discriminates the type of the command (ACT 22, ACT 26).

When the received command is an urgent distribution instruction command (YES in ACT 22), the CPU 21 saves the urgent distribution file 243 added to that command, in the HDD 24 (ACT 23). The CPU 21 also sets the file name of the urgent distribution file 243 in the area of urgent distribution file name corresponding to each table number in the display management table 244. The CPU 21 further sets all the urgent distribution flags in the flag area corresponding to each table number to “1” (ACT 24).

After that, the CPU 21 switches the content reproduced at each digital signage terminal 30, from the data of the content file 241 having the file name set in the content file name area to the data of the urgent distribution file 243 having the file name set in the urgent distribution file name area (ACT 25). Then, the CPU 21 ends the reception of the urgent distribution instruction command.

Meanwhile, when the received command is an urgent distribution end instruction command (YES in ACT 26), the CPU 21 returns the content reproduced at each digital signage terminal 30, from the data of the urgent distribution file 243 to the data of the content file 241 (ACT 27). The CPU 21 also resets all the urgent distribution flags in the display control table 244 to “0” (ACT 28). Then, the CPU 21 ends the reception of the urgent distribution end instruction command.

In this manner, when the start time of a preferential treatment project comes, the contents reproduced at respective digital signage terminals 30 are switched simultaneously to a content specialized in the event content of the preferential treatment project. The reproduction of the content specialized in the event content continues until the project ends. When the project ends, the reproduction of the content according to the initial schedule is restored.

Thus, according to the first embodiment, linked with the implementation of the preferential treatment project, information specialized in the project can be presented to shoppers, using the digital signage system.

### Second Embodiment

A second embodiment has the configuration of the first embodiment, and in addition, the content management server 10 saves a display article database 143 in the HDD 14.

As shown in FIG. 11, in the displayed article database 143, displayed article data records describing terminal ID and displayed article information are stored in order of record number. The terminal ID is identification information for specifying each individual digital signage terminal 30. The displayed article information includes an article category code for specifying an article group displayed near the installation place of the digital signage terminal 30 specified by the corresponding terminal ID. When there are plural article groups, the article category code of each article group is described as the displayed article information.

Here, the display article database 143 constitutes a first storage unit in which, in association with information (terminal ID) for identifying each of the plural digital signage terminals 30, information (article category code) for identifying plural articles allocated to the digital signage terminal 30 is stored.

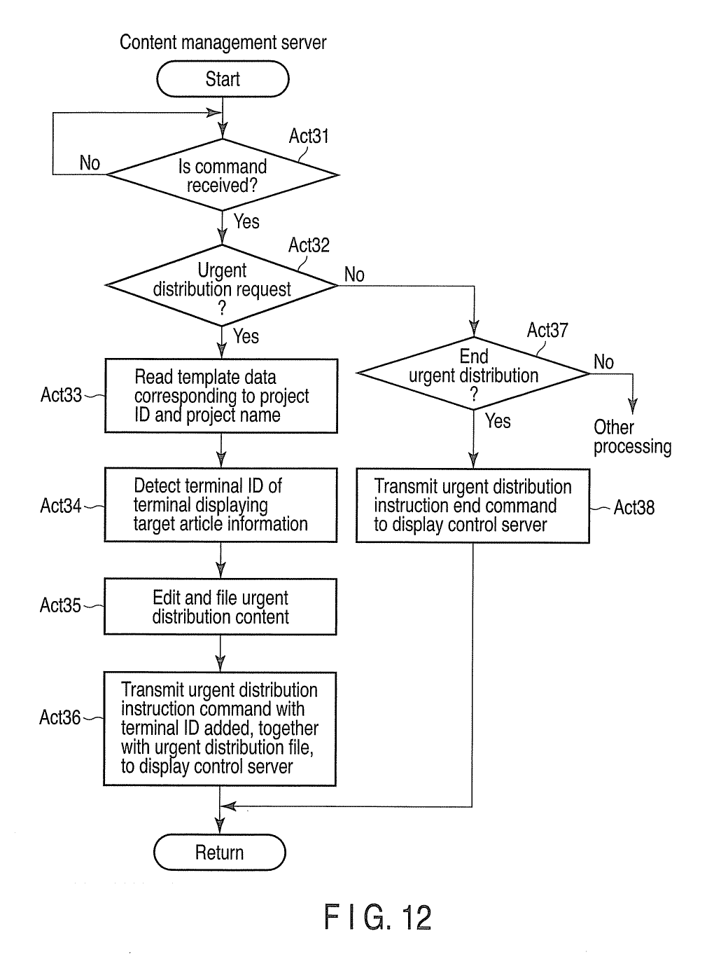

In the second embodiment, the CPU 11 of the content management server 10 executes command reception according to the procedures shown in the flowchart of FIG. 12.

The CPU 11 waits for a command (ACT 31). When a command is received via the communication interface 15 (YES in ACT 31), the CPU 11 discriminates the type of the command (ACT 32, ACT 36).

When the received command is an urgent distribution request command (YES in ACT 32), the CPU 11 detects the project ID and project name from the command. The CPU 11 then reads a template data record Rt which coincides with this project ID and project name from the template database 142 (ACT 33).

The CPU 11 accesses the POS server 70 via the communication network 40 and reads article information (article name, article category code, regular unit price, special unit price and the like) registered in the article database 741 in association with the article code included in the target article information in the received command. The CPU 11 then detects the terminal ID from the record in the display article database 143 in which the article category code of the article information that is read is described (ACT 34: first selecting unit).

The CPU 11 edits the urgent distribution content of digital signage based on the template data record Rt, the reproduction image template data and the article information which are read (ACT 35: editing unit). The edited urgent distribution content is registered as the urgent distribution file 243 in the material database 141.

The CPU 11 creates an urgent distribution instruction command. The CPU 11 transmits this command together with the urgent distribution file 243 registered in the material database 141 and the detected terminal ID to the display control server 20 via the communication interface 15 (ACT 36: transmitting unit). Then, the CPU 11 ends the reception of the urgent distribution request command.

Meanwhile, when the received command is an urgent distribution end command (YES in ACT 37), the CPU 11 creates an urgent distribution instruction end command. The CPU 11 transmits this command to the display control server 20 via the communication interface 15 (ACT 38: transmitting unit). Then, the CPU 11 ends the reception of the urgent distribution end command.

In this manner, when a start command (urgent distribution request command) of a preferential treatment project is generated at the POS server 70, the content management server 10 edits a digital signage content specialized in the event content of the project and creates the urgent distribution file 243. The content management server 10 then transmits the urgent distribution file 243 together with an urgent distribution instruction command to the display control server 20. Here, the content management server 10 adds, to the urgent distribution instruction command, the terminal ID of the digital signage terminal 30 to which the article category code of the target article of the preferential treatment project is allocated, and then transmits the command.

When an end command (urgent distribution end command) of this preferential treatment project is generated at the POS server 70, the content management server 10 transmits an urgent distribution end instruction command to the display control server 20.

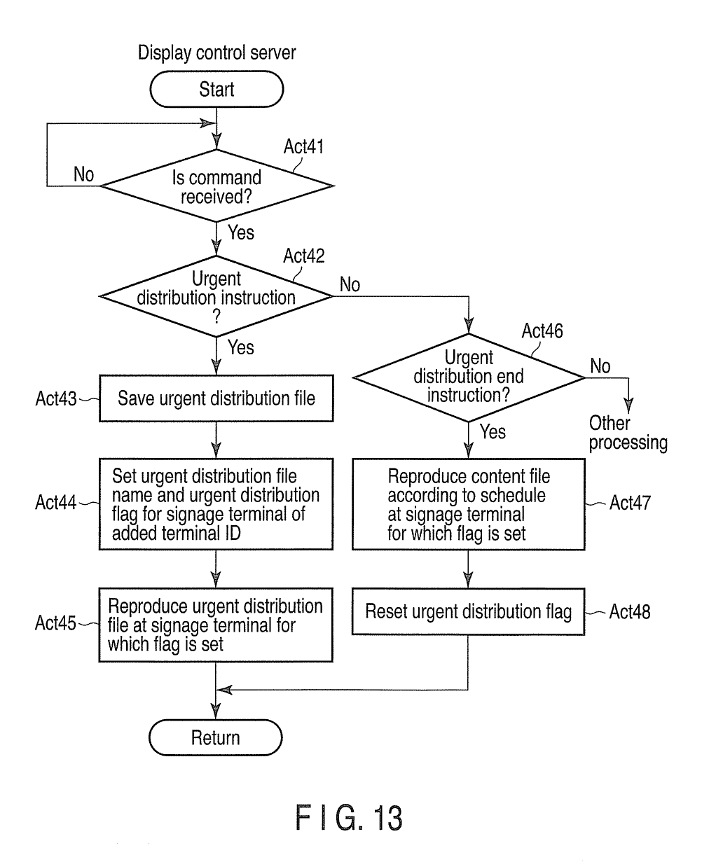

The CPU 21 of the display control server 20 receiving the urgent distribution instruction command and the urgent distribution end instruction command executes processing according to the procedures shown in the flowchart of FIG. 13.

The CPU 21 waits for a command (ACT 41). When a command is received via the first communication interface 26 (YES in ACT 41), the CPU 21 discriminates the type of the command (ACT 42, ACT 46).

When the received command is an urgent distribution instruction command (YES in ACT 42), the CPU 21 saves the urgent distribution file 243 added to that command, in the HDD 24 (ACT 43). The CPU 21 also detects a terminal ID from that command. The CPU 21 sets the file name of the urgent distribution file 243 in the area of the urgent distribution name of the record for which the detected terminal ID is set, of the records in the display management table 244. The CPU 21 then sets the urgent distribution flag to “1” in the flag area of the record for which the file name of the urgent distribution file 243 is set (ACT 44).

After that, the CPU 21 switches the content reproduced at the digital signage terminal 30 having the terminal ID with the urgent distribution flag set to “1”, from the data of the content file 241 having the file name set in the content file name area to the data of the urgent distribution file 243 having the file name set in the urgent distribution file name area (ACT 45). Then, the CPU 21 ends the reception of the urgent distribution instruction command.

Meanwhile, when the received command is an urgent distribution end instruction command (YES in ACT 46), the CPU 21 returns the content reproduced at the digital signage terminal 30 having the terminal ID with the urgent distribution flag set to “1”, from the data of the urgent distribution file 243 to the data of the content file 241 (ACT 47). The CPU 21 also resets the urgent distribution flag, which is set to “1” in the display control table 244, to “0” (ACT 48). Then, the CPU 21 ends the reception of the urgent distribution end instruction command.

In this manner, when the start time of a preferential treatment project comes, the content reproduced at the digital signage terminal 30 installed near the place where the project target article is displayed, from among the digital signage terminals 30, is switched to a content specialized in the event content of the preferential treatment project. The reproduction of the content specialized in the event content continues until the project ends. When the project ends, the reproduction of the content according to the initial schedule is restored.

Thus, according to the second embodiment, linked with the implementation of the preferential treatment project, information specialized in the project can be presented to shoppers near the place where the corresponding article of the project is displayed, using the digital signage system.

### Third Embodiment

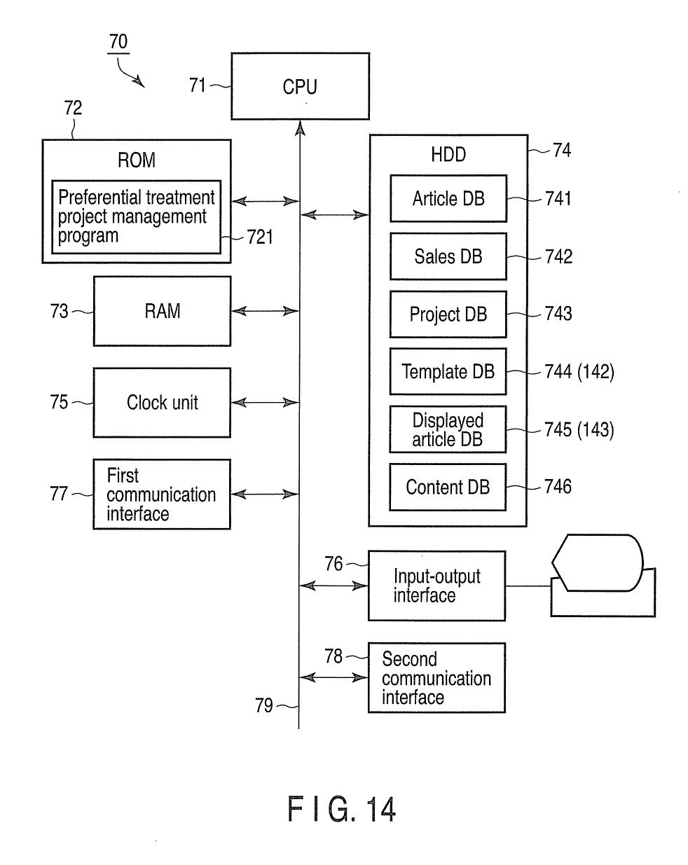

FIG. 14 is a block diagram showing the configuration of essential parts of the POS server 70 in a third embodiment. The parts common to FIG. 6 and FIG. 14 are denoted by the same reference numerals. In the POS server 70, a template database 744, a displayed article database 745 and a content database 746 are saved in the HDD 74. The template database 744 is similar to the template database 142 described in the first embodiment. The displayed article database 745 is similar to the displayed article database 143 described in the second embodiment.

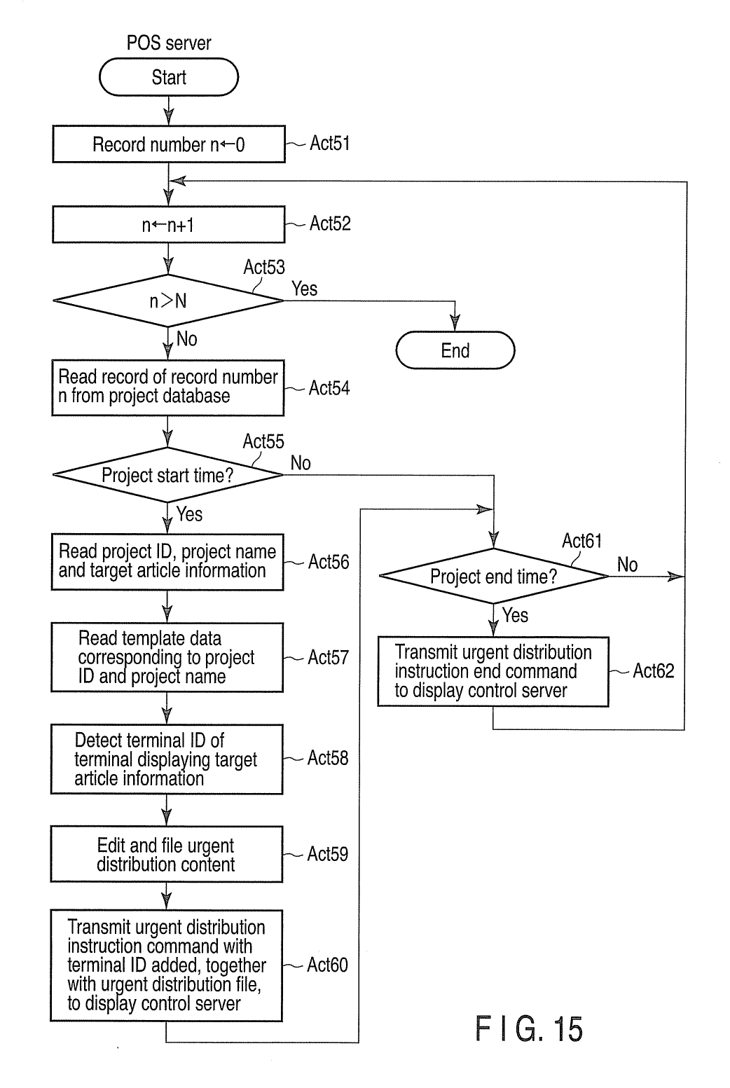

The CPU 71 of the POS server 70 starts processing according to the procedures shown in the flowchart of FIG. 15 every time the current time measured by the clock unit 75 passes, for example, by one minute.

First, the CPU 71 resets the record number counter n to “0” (ACT 51). Next, the CPU 71 increments the record number counter n by “1” (ACT 52). The CPU 71 then determines whether the counter n is greater than a preset value N or not (ACT 53). The preset value N is the total number of project data records registered in the project database 743.

When the counter n is not greater than the preset value N (NO in ACT 53), the CPU 71 reads a project data record Rn of record number n (n being the count value) from the project database 743 (ACT 54). The CPU 71 determines whether the start time of the record Rn coincides with the current time or not (ACT 55).

When the start time coincides with the current time (YES in ACT 55), the CPU 71 detects the project ID, project name and target article information from the record Rn (ACT 56). The CPU 71 then reads the template data record Rt coinciding with this project ID and project name from the template database 744 (ACT 57). The CPU 71 also reads the article information registered in the article database 741, corresponding to the article code included in the target article information. The CPU 71 then detects the terminal ID from the record in the displayed article database 745 describing the article category code included in this article information (ACT 58: first selecting unit).

The CPU 71 edits the urgent distribution content of digital signage based on the template data record Rt, the reproduction image template data and the article information which are read (ACT 59: editing unit). The edited urgent distribution content is registered as the urgent distribution file 243 in the content database 746.

The CPU 71 then creates an urgent distribution instruction command. The CPU 71 then transmits this command together with the urgent distribution file 243 registered in the content database 746 and the detected terminal ID, to the display control server 20 via the communication interface 77 (ACT 60: transmitting unit).

Meanwhile, when the start time of the project data record Rn does not coincide with the current time (NO in ACT 55), the CPU 71 does not execute the processing of ACT 56 to ACT 60.

The CPU 71 determines whether the end time of the project data record Rn coincides with the current time measured by the clock unit 75 or not (ACT 61). When the end time does not coincide with the current time (NO in ACT 61), the CPU 71 returns to the processing of ACT 52. The CPU 71 then increments the counter n further by “1” and executes the processing of ACT 53 and the subsequent processing again.

Meanwhile, when the end time of the project data record Rn coincides with the current time (YES in ACT 61), the CPU 71 creates an urgent distribution instruction end command. The CPU 71 then transmits the command to the display control server 20 via the communication interface 77 (ACT 62: transmitting unit).

After that, the CPU 71 returns to the processing of ACT 52. The CPU 71 then increments the counter n further by “1” and executes the processing of ACT 53 and the subsequent processing again.

In this manner, the CPU 71 repeats processing of ACT 53 to ACT 62 every time the counter n is incremented. When the counter n exceeds the preset value N (YES in ACT 53), the CPU 71 ends the processing of this time.

Thus, when the start time of a preferential treatment project registered in the project database 743 comes, the POS server 70 edits the digital signage content specialized in the event content of the project and creates the urgent distribution file 243. The POS server 70 then transmits this urgent distribution file 243 together with an urgent distribution instruction command to the display control server 20. Here, the POS server 70 adds, to the urgent distribution instruction command, the terminal ID of the digital signage terminal 30 to which the article category code of the target article of the preferential treatment project is allocated, and transmits the command.

The POS server 70 transmits an urgent distribution end instruction command for the content outputted from the digital signage terminal 30 to the display control server 20 when the end time of the preferential treatment project comes.

The processing procedures executed by the CPU 21 of the display control server 20 receiving the urgent distribution instruction command and the urgent distribution end instruction command are the same as the procedures shown in the flowchart of FIG. 13 described in the second embodiment.

In this manner, according to the third embodiment, similar effects to the effects of the second embodiment can be realized while omitting the content management server 10.

In the third embodiment, the CPU 71 omits the processing of ACT 58. Then, in ACT 60, The CPU 71 transmits the urgent distribution instruction command to the display control server 20 without adding the terminal ID. As such configuration is employed, when the start time of a preferential treatment project comes, the contents reproduced and displayed at respective digital signage terminals 30 are switched simultaneously to a content specialized in the event content of the preferential treatment project, as in the first embodiment.

### Fourth Embodiment

A fourth embodiment has the configuration of the third embodiment, and in addition, a related database 747 of content sales is saved in the HDD 74 of the POS server 70.

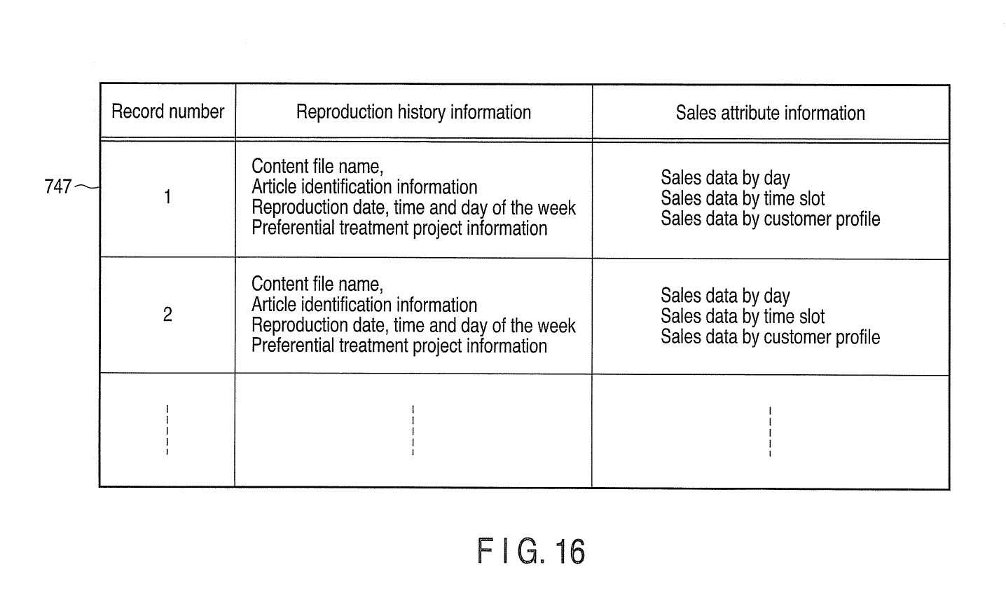

As shown in FIG. 16, in the related database 747, related data records describing reproduction history information and sales attribute information of urgent distribution contents are stored in order of record number.

The reproduction history information includes content file name, article identification information, reproduction date, time and day of the week, and preferential treatment project information. The content file name is the name of the urgent distribution file 243 in which data of an urgent distribution content is saved. The article identification information includes the article code, article name, article category code or the like of a target article of the urgent distribution content. The preferential treatment project information is the project ID, project name or the like of the urgent distribution content.

The sales attribute information includes sales data by day, sales data by time slot and sales data by customer profile, of the article identified by the article identification information of the corresponding reproduction history information. The sales data is at least one of the number of items sold and the amount of sales.

Here, the related database 747 constitutes a second storage unit in which, in association with information (reproduction history information) for identifying each content, actual article sales information (sales attribute information) when the content is outputted form the signage terminal is stored.

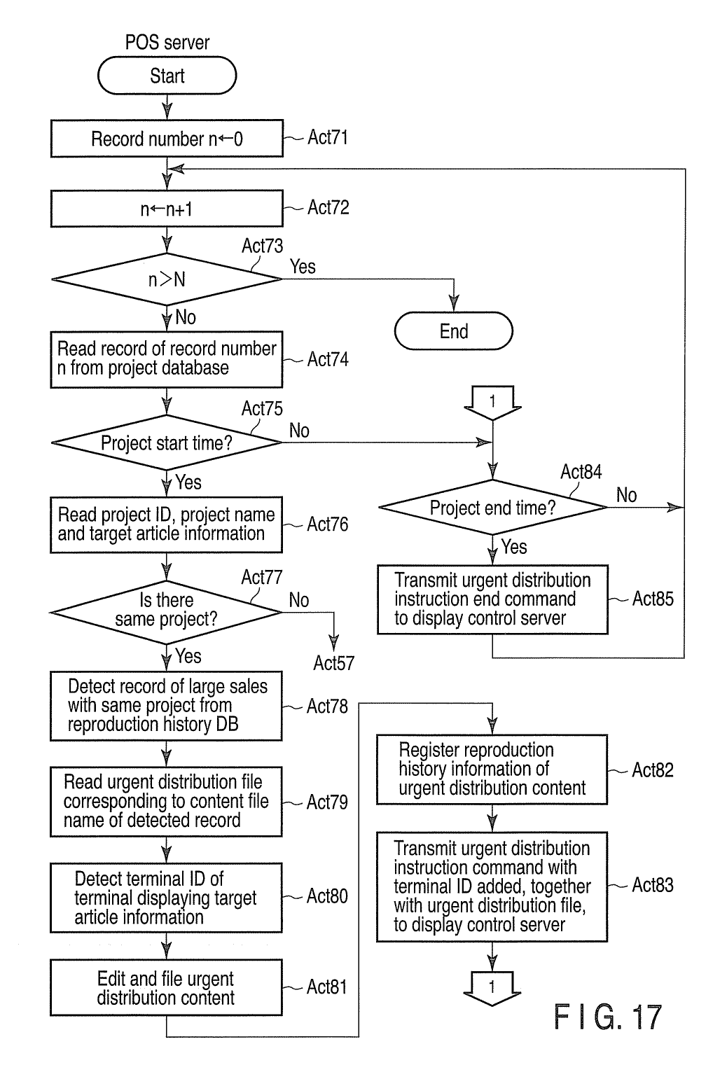

The CPU 71 of the POS server 70 starts processing according to the procedures shown in the flowchart of FIG. 17 every time the current time measured by the clock unit 75 is updated, for example, by one minute.

First, the CPU 71 resets the record number counter n to “0” (ACT 71). Next, the CPU 71 increments the record number counter n by “1” (ACT 72). The CPU 71 then determines whether the counter n is greater than a preset value N or not (ACT 73). The preset value N is the total number of project data records registered in the project database 743.

When the counter n is not greater than the preset value N (NO in ACT 73), the CPU 71 reads a project data record Rn of record number n (n being the count value) from the project database 743 (ACT 74). The CPU 71 determines whether the start time of the record Rn coincides with the current time or not (ACT 75).

When the start time coincides with the current time (YES in ACT 75), the CPU 71 detects the project ID, project name and target article information from the record Rn (ACT 76). The CPU 71 then searches the related database 747 using the project ID and project name, and determines whether there is a related data record having reproduction history information describing the same project ID and project name as preferential treatment project information (ACT 77).

When there is no related data record having the corresponding reproduction history information (NO in ACT 77), the CPU 71 goes to the processing of ACT 57 described in the third embodiment.

Meanwhile, when there are related data records having the corresponding reproduction history information (YES in ACT 77), the CPU 71 detects the record showing the largest sales, from among the related data records.

Here, the user can arbitrarily set which of the sales data by day, by time slot and by customer profile should be compared to determine the largest sales. For example, when the user wants to make a determination based on reproduction time, the sales data by time slot is set in advance as a comparison target. As the sales data by time slot is used as a comparison target, the related data record showing the largest sales in the time slot to which the current time belongs is detected.

When the related data record showing the largest sales is detected, the CPU 71 acquires the content file name from the reproduction history information in the record. The CPU 71 then reads the urgent distribution file 243 in which this file name is set, from the content database 746 (ACT 79: second selecting unit).

Next, the CPU 71 reads the article information registered in the article database 741, corresponding to the article code included in the target article information. The CPU 71 then detects the terminal ID from the record in the displayed article database 745 describing the article category code included in this article information (ACT 80: first selecting unit).

The CPU 71 edits the urgent distribution content of digital signage based on the data of the urgent distribution file 243 and the article information which are read (ACT 81: editing unit). The edited urgent distribution content is registered as the urgent distribution file 243 in the content database 746.

The CPU 71 also creates reproduction history information using the file name of the urgent distribution file 243, the article identification information detected from the project data record Rn, the current date, time and day of the week, and the preferential treatment project information detected from the project data record Rn. The CPU 71 then adds a new record number and registers this reproduction history information in the related database 747 (ACT 82).

The CPU 71 creates an urgent distribution instruction command. Then CPU 71 then transmits this command together with the urgent distribution file 243 registered in the content database 746 and the detected terminal ID, to the display control server 20 via the communication interface 77 (ACT 83: transmitting unit).

Meanwhile, when the start time of the project data record Rn does not coincide with the current time (NO in ACT 75), the CPU 71 does not execute the processing of ACT 76 to ACT 83.

The CPU 71 determines whether the end time of the record Rn coincides with the current time or not (ACT 84). When the end time does not coincide with the current time (NO in ACT 84), the CPU 71 returns to the processing of ACT 72. The CPU 71 then increments the counter n further by “1” and executes the processing of ACT 73 and the subsequent processing again.

Meanwhile, when the end time of the project data record Rn coincides with the current time (YES in ACT 84), the CPU 71 creates an urgent distribution instruction end command. The CPU 71 then transmits the command to the display control server 20 via the communication interface 77 (ACT 85: transmitting unit).

After that, the CPU 71 returns to the processing of ACT 72. The CPU 71 then increments the counter n further by “1” and executes the processing of ACT 73 and the subsequent processing again.

In this manner, the CPU 71 repeats processing of ACT 73 to ACT 85 every time the counter n is incremented. When the counter n exceeds the preset value N (YES in ACT 73), the CPU 71 ends the processing of this time.

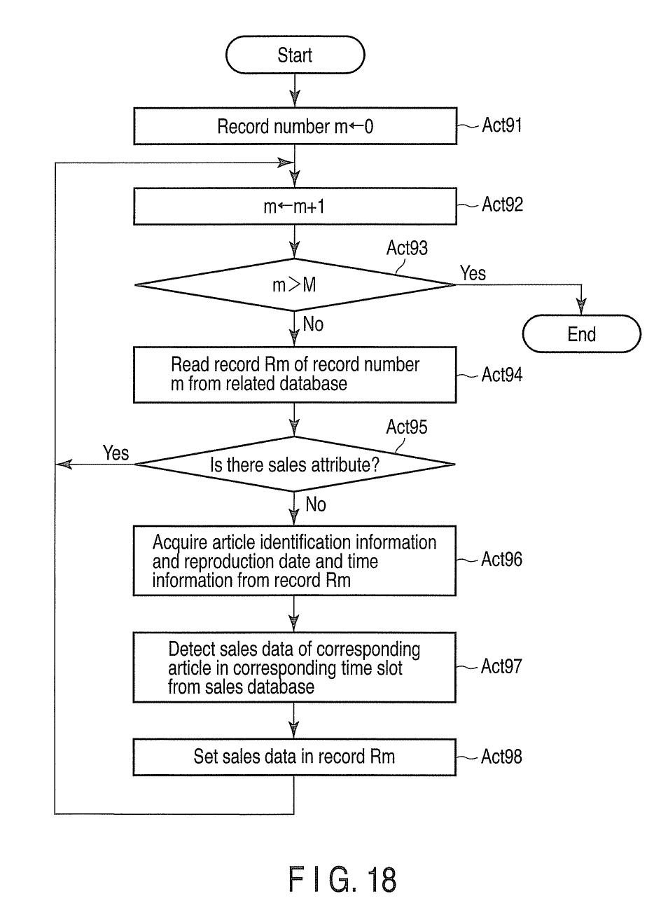

In this fourth embodiment, the CPU 71 of the POS server 70 also executes the processing shown in the flowchart of FIG. 18. This processing is to associate the urgent distribution content with sales and is carried out during the processing of a store closing operation program executed after the store is closed every business day.

First, the CPU 71 resets the record number counter m to “0” (ACT 91). Next, the CPU 71 increments the record number counter m by “1” (ACT 92). The CPU 71 then determines whether the counter m is greater than a preset value M or not (ACT 93). The preset value M is the total number of related data records registered in the related database 747.

When the counter m is not greater than the preset value M (NO in ACT 93), the CPU 71 reads a related data record Rm of record number m (m being the count value) from the related database 747 (ACT 94). The CPU 71 determines whether sales attribution information is set in this record Rm or not (ACT 95).

When sales attribute information is set (YES in ACT 95), the CPU 71 returns to the processing of ACT 92. The CPU 71 then increments the counter m further by “1” and executes the processing of ACT 93 and the subsequent processing again.

When sales attribute information is not set (NO in ACT 95), this related data record Rm relates to an urgent distribution content created on this business day. In this case, the CPU 71 acquires article identification information and reproduction date and time information from the reproduction history information of the related data record Rm (ACT 96). The CPU 71 then searches the sales database 742 using the article identification information and the reproduction date and time information, and detects sales attribute data of the corresponding article, that is, sales data by day, sales data by time slot and sales data by customer profile (ACT 97). The CPU 71 sets these sales attribute data as the sales attribute information of the related data record Rm and re-registers the sales attribute data in the related database 747 (ACT 98).

After that, the CPU 71 returns to the processing of ACT 92. The CPU 71 then increments the counter m further by “1” and executes the processing of ACT 93 and the subsequent processing again.

Thus, the CPU 71 repeats the processing of ACT 93 to ACT 98 every time the counter m is incremented. When the counter m exceeds the preset value M (YES in ACT 93), the CPU 71 ends the processing of this time.

In this manner, every time a digital signage content specialized in the event content of a preferential treatment project is created, the POS server 70 associates sales attribute information with reproduction history information related to the content and saves the information in the related database 747. The sales attribute information is the actual sales in the time slot when the content is reproduced at the digital signage terminal 30.

When a new preferential treatment project is started, the POS server 70 compares the actual sales information acquired when the contents of similar projects are displayed, and selects the content showing the largest sales. Based on the data of this content, the POS server 70 then creates data of a content for the new preferential treatment project.

Thus, according to the fourth embodiment, a content with a high sales promotion effect can be created and presented to shoppers.

The invention is not limited to the embodiments. In practice, components can be modified and embodied without departing from the scope of the invention.

For example, the embodiments are described, targeting one store. However, the content management serve 10 may be shared by plural stores. In this case, connecting a server specialized in selectively distributing content files edited by the content management serve 10 to the display control server 20 in each store, to the communication network 40, is efficient.

The digital signage terminal 30 may not have a display capable of displaying a dynamic image or still image. For example, a paper-like display device or an electronic shelf label device may be applied as the digital signage terminal 30.

Moreover, in the embodiments, the program as the functions to carry out the invention is recorded in advance within the apparatus. However, without being limited to these embodiments, similar functions may be downloaded to the apparatus from a network or a recording medium having similar functions may be installed in the apparatus. The recording medium may be any form of recording medium in which the program can be stored and which can be read by the apparatus, such as CD-ROM. The functions acquired by installation or download may also be realized in cooperation with the OS (operating system) within the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control apparatus for a digital signage terminal which outputs a content of digital signage according to a predetermined schedule, the apparatus comprising:
an editing unit which edits, when a POS server which processes article sales data as of when article information is inputted generates a start command for an event related to article sales promotion, a content of digital signage specialized in a content of the event; and
a transmitting unit which transmits, to the digital signage terminal, the edited content together with an instruction command for switching a content outputted from the digital signage terminal, from the content according to the schedule to the edited content.

2. The apparatus of claim 1, wherein when the POS server generates an end command for the event, the transmitting unit transmits, to the digital signage terminal, an instruction end command for returning the content outputted from the digital signage terminal, from the edited content to the content according to the schedule.

3. The apparatus of claim 1, further comprising:
a first storage unit in which, in association with information for identifying each of a plurality of the digital signage terminals, article identification information allocated to the digital signage terminal is stored; and
a first selecting unit which selects the digital signage terminal associated with an article related to the event for which the start command is generated at the POS terminal, based on the article identification information in the first storage unit;
wherein the transmitting unit transmits the content and the instruction command together with information for specifying the digital signage terminal selected by the selecting unit.

4. The apparatus of claim 2, further comprising:
a first storage unit in which, in association with information for identifying each of a plurality of the digital signage terminals, article identification information allocated to the digital signage terminal is stored; and
a first selecting unit which selects the digital signage terminal associated with an article related to the event for which the start command is generated at the POS terminal, based on the article identification information in the first storage unit;
wherein the transmitting unit transmits the content and the instruction command together with information for specifying the digital signage terminal selected by the selecting unit.

5. The apparatus of claim 1, further comprising:
a second storage unit in which, in association with information for identifying each content edited by the editing unit, actual article sales information as of when the content is outputted from the digital signage terminal is stored; and
a second selecting unit which selects a content showing large actual sales from among a content group associated with a similar event to the event of the start command generated at the POS terminal, based on the actual sales information in the second storage unit;
wherein the editing units edits the content of this time based on data of the content selected by the second selecting unit.

6. The apparatus of claim 2, further comprising:
a second storage unit in which, in association with information for identifying each content edited by the editing unit, actual article sales information as of when the content is outputted from the digital signage terminal is stored; and
a second selecting unit which selects a content showing large actual sales from among a content group associated with a similar event to the event of the start command generated at the POS terminal, based on the actual sales information in the second storage unit;
wherein the editing units edits the content of this time based on data of the content selected by the second selecting unit.

7. The apparatus of claim 3, further comprising:
a second storage unit in which, in association with information for identifying each content edited by the editing unit, actual article sales information as of when the content is outputted from the digital signage terminal is stored; and
a second selecting unit which selects a content showing large actual sales from among a content group associated with a similar event to the event of the start command generated at the POS terminal, based on the actual sales information in the second storage unit;
wherein the editing units edits the content of this time based on data of the content selected by the second selecting unit.

8. The apparatus of claim 1, wherein the editing unit and the transmitting unit are provided in a content management server which manages data of the content and an output schedule of the content.

9. The apparatus of claim 3, wherein the editing unit, the transmitting unit and the first selecting unit are provided in a content management server which manages data of the content and an output schedule of the content.

10. The apparatus of claim 1, wherein the editing unit and the transmitting unit are provided in the POS server.

11. The apparatus of claim 3, wherein the editing unit, the transmitting unit and the first selecting unit are provided in the POS server.

12. The apparatus of claim 5, wherein the editing unit, the transmitting unit, the first selecting unit and the second selecting unit are provided in the POS server.

13. A control method for a digital signage terminal which outputs a content of digital signage according to a predetermined schedule, the method comprising:
when a POS server which processes article sales data as of when article information is inputted generates a start command for an event related to article sales promotion, editing a content of digital signage specialized in a content of the event;
transmitting, to the digital signage terminal, the edited content together with an instruction command for switching a content outputted from the digital signage terminal, from the content according to the schedule to the edited content; and
when the POS server generates an end command for the event, transmitting, to the digital signage terminal, an instruction end command for returning the content outputted from the digital signage terminal, from the edited content to the content according to the schedule.
